(19) United States
(12) Patent Application Publication
(10) Pub. No.: US 2025/0208559 A1
(43) Pub. Date: Jun. 26, 2025

(54) CLEANING DEVICE

(71) Applicant: CANON KABUSHIKI KAISHA, Tokyo (JP)

(72) Inventor: YUSUKE OIZUMI, Ibaraki (JP)

(21) Appl. No.: 18/983,166

(22) Filed: Dec. 16, 2024

(30) Foreign Application Priority Data
Dec. 23, 2023 (JP) 2023-217491
Dec. 5, 2024 (JP) 2024-212383

(51) Int. Cl. G03G 21/00; B08B 1/16

(52) U.S. Cl. CPC G03G 21/0011; B08B 1/165

(57) ABSTRACT

A cleaning device includes a blade, a support plate for supporting the blade and a reinforcing plate fixed to the support plate. The support plate is provided with a first flat portion and a first one end portion and a first the other end portion of the first flat portion. The reinforcing plate is provided with a second flat portion disposed along a longitudinal direction so as to be along the first flat portion, a second one end portion and a second the other end portion of the second flat portion. As viewed in the longitudinal direction, the second one end portion is provided with a projecting portion projecting from the second flat portion in a first direction crossing a short side direction and the first the other end portion is provided with a support plate projecting portion projecting in a second direction opposite to the first direction.

### FIELD OF THE INVENTION AND RELATED ART

The present invention relates to a cleaning device for an image forming apparatus.

Conventionally, for example, in an image forming apparatus such as a copier which applies an electrophotographic process and forms an image, toner on an image bearing member is removed by a cleaning device. As the cleaning device, a cleaning blade (hereinafter referred to as “blade”) as a cleaning member, which is pressed against a surface of the image bearing member and scrapes off and removes the toner on the image bearing member is often used.

In such a cleaning device, when contact pressure of the blade against the image bearing member changes, it may cause cleaning failure, turn-up the cleaning blade or make an unusual noise. Contact pressure of the blade against the image bearing member may be caused by a change in a position of the blade relative to the image bearing member. Therefore, it is important to properly support the blade and maintain its position relative to the image bearing member with high precision.

In the image forming apparatus disclosed in the Japanese Laid-Open Patent Application (JP-A) 2016-130819, a support plate which is bent into a substantially L-shape in cross section is used as a support member which support the blade. It is possible to suppress deformation of the support plate due to a reaction force which is applied to the blade by bending the support plate into the substantially L-shape in cross section and rigidity of the support plate is increased. However, in a conventional configuration, a bending portion, which is the substantially L-shape in cross section in order to increase the rigidity of the support plate, is provided away from a contact portion of the blade against the image bearing member. Therefore, in the conventional configuration, in order to sufficiently increase the rigidity against the reaction force which is applied to the blade, it is necessary to increase bending height of the substantially L-shape in cross section. And size of the image forming apparatus may increase in order to secure space for the bending height.

### SUMMARY OF THE INVENTION

And an object of the present invention is to effectively increase the rigidity of the support configuration of the blade in a small space.

The object which is described above is achieved by the cleaning device according to the present invention. In summary, according to an aspect of the present invention, there is provided a cleaning device comprising: a blade in contact with a surface of an image bearing member along a longitudinal direction and configured to remove toner from the surface of the image bearing member in a contacting portion to the image bearing member; a support plate configured to support the blade; a reinforcing plate fixed to the support plate; wherein the support plate is provided with a first flat portion disposed along the longitudinal direction and including a fixing portion to which the blade is fixed, a first one end portion of the first flat portion on a side close to the contacting portion with respect to a short side direction of the blade, and a first the other end portion of the first flat portion on a side far from the contacting portion; wherein the reinforcing plate is provided with a second flat portion disposed along the longitudinal direction so as to be along the first flat portion, a second one end portion of the second flat portion on a side close to the contacting portion with respect to the short side direction of the blade, and a second the other end portion of the second flat portion on a side far from the contacting portion; and wherein as viewed in the longitudinal direction, the second one end portion is provided with a first projecting portion projecting from the second flat portion in a first direction crossing the short side direction of the blade and the second the other end portion is provided with a second projecting portion projecting in a second direction opposite to the first direction.

Further, according to another aspect of the present invention, there is provided an image forming apparatus which includes the image bearing member on which the toner image is formed and the cleaning device which is described above.

Further features of the present invention will become apparent from the following description of exemplary embodiments with reference to the attached drawings.

### BRIEF DESCRIPTION OF THE DRAWINGS

FIG. 1 is a schematic cross sectional view of an image forming apparatus.

FIG. 2 is a cross sectional view of the image forming portion.

FIG. 3 is a schematic cross sectional view of a drum cartridge.

FIG. 4 is an exploded perspective view of a cleaning device.

FIG. 5 is a top view of a support configuration of a blade.

FIG. 6 is a cross sectional view of the drum cartridge showing a modified example of the support configuration of the blade.

FIG. 7 is a top view showing the modified example of the support configuration of the blade.

FIG. 8 is a cross sectional view of the drum cartridge showing the modified example of the support configuration of the blade.

FIG. 9 is a cross sectional view of the drum cartridge showing the modified example of the support configuration of the blade.

FIG. 10 is a cross sectional view of a conventional cleaning device.

### DESCRIPTION OF THE EMBODIMENTS

In the following, the cleaning device according to the present invention will be more specifically described with reference to Figures.

### REFERENCE EXAMPLE

### 1. Overall Configuration and Operation of the Image Forming Apparatus

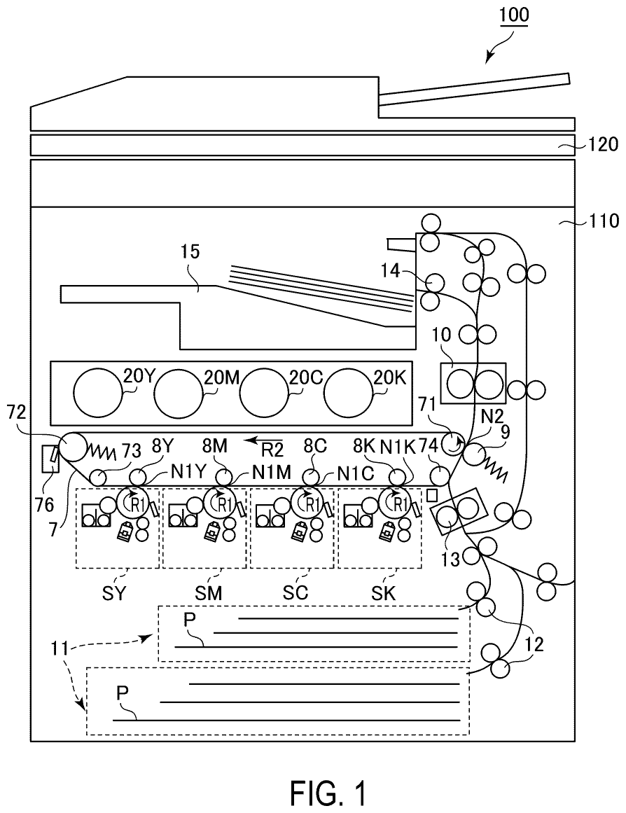

First of all, an overall configuration and an operation of the image forming apparatus in a reference example will be described. FIG. 1 is a schematic cross sectional view of the image forming apparatus 100 in the reference example (a cross sectional view is shown in a direction which is substantially perpendicular to a direction of a rotational axis of a photosensitive drum 1 which will be described below). The image forming apparatus 100 in the reference example is a tandem type multifunction printer (including functions of a copier, a printer and fax machine) which applies an intermediate transfer method and is capable of forming full-color images by using an electrophotographic method. The image forming apparatus 100 is possible to form an image on a recording material P which is a sheet such as paper, according to image information which is sent from an external device such as a personal computer and image information which is read by an image reading portion 120 which is provided with the image forming apparatus 100.

Here, a front side of paper in FIG. 1 is a “front (front surface) side” and a back side of the paper is a “back (back surface) side” with respect to the image forming apparatus 1 and its elements. A front-back direction which connects the front side and the back side is supposed to be substantially parallel to the direction of the rotational axis of the photosensitive drum 1 which will be described below. Further, with respect to the image forming apparatus 1 and its elements, an up-down direction refers to a direction of gravity (vertical direction), however, it does not mean only directly above and directly below, respectively, but it includes an upper side and a lower side than a horizontal plane which passes through a target element or position.

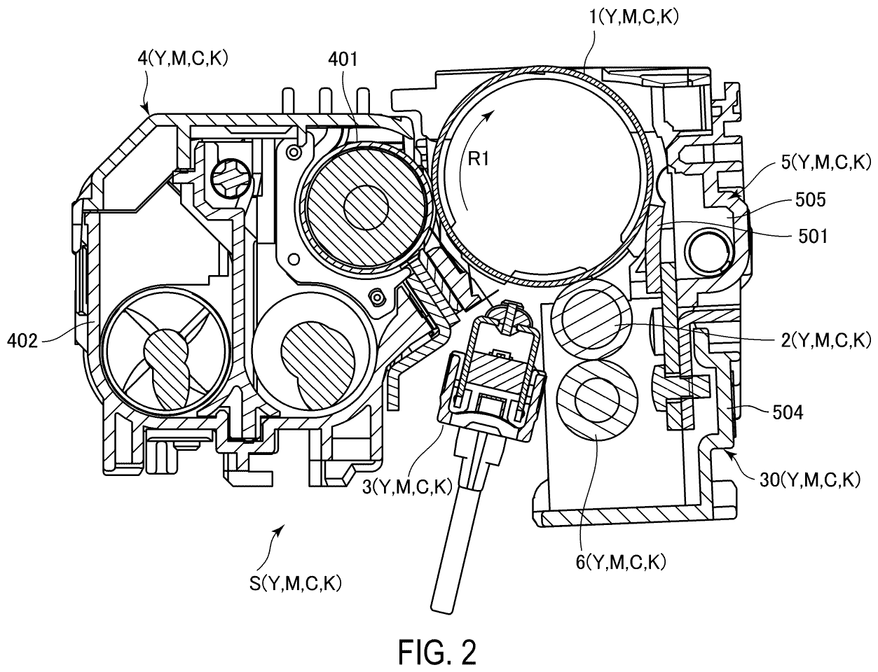

The image forming apparatus 100 includes four image forming portions SY, SM, SC and SK, which form images of yellow (Y), magenta (M), cyan (C) and black (K), respectively, as a plurality of image forming portions (stations). Configurations and operations of the image forming portions SY, SM, SC and SK, are essentially identical, except that colors of toners which are used are different. Incidentally, an element which has same or corresponding function or configuration for each color may be described collectively by omitting ends of reference numerals Y, M, C and K for the element for one of the colors. FIG. 2 is a cross sectional view showing one of the image forming portions S as a representative example. In the reference example, the image forming portion S is configured to include photosensitive drums 1 (1Y, 1M, 1C, 1K), charging rollers 2 (2Y, 2M, 2C, 2K), exposure devices 3 (3Y, 3M, 3C, 3K), developing devices 4 (4Y, 4M, 4C, 4K), cleaning devices 5 (5Y, 5M, 5C, 5K) and cleaning rollers 6 (6Y, 6M, 6C, 6K), etc.

The image forming portion S is provided with a photosensitive drum 1, which is a rotatable drum shaped (cylindrical) photosensitive member (electrophotographic photosensitive member) as a first image bearing member. The photosensitive drum 1 is rotationally driven in a direction of an arrow R1 (clockwise direction) in figures when a driving force is transmitted from a drum driving portion as a driving means which is not shown in the figures. A surface of the rotating photosensitive drum 1 is uniformly charged to a predetermined potential of a predetermined polarity (negative polarity in the reference example) by the charging roller 2 which is a roller-shaped charging member as a charging means. The charging roller 2 is arranged in contact with the surface of the photosensitive drum 1, and is rotationally driven accompanied by the rotation of the photosensitive drum 1. During a charging process, the charging roller 2 is charged with a predetermined charging voltage (charging bias) by a charging power source (high-voltage power source) as a charging voltage application portion which is not shown in the figures. Thus, a discharge of electricity is occurred between the surface of the charging roller 2 and the surface of the photosensitive drum 1, and the surface of the photosensitive drum 1 is charged.

The surface of the photosensitive drum 1, which is charged, is exposed by the exposure device 3 as an exposure means (electrostatic image forming means), and an electrostatic image (electrostatic latent image) is formed on the photosensitive drum 1. In the reference example, the exposure device 3 irradiates the surface of the photosensitive drum 1 with light which is emitted by an LED as a light source according to image information (image signal). Incidentally, the exposure device 3 may be a laser scanner device, etc., and may be also configured, for example, as a single unit which exposes the four photosensitive drums 1.

The electrostatic image which is formed on the photosensitive drum 1 is developed (visualized) when the toner is supplied by the developing device 4 as a developing means, and a toner image (toner picture, developer image) is formed on the photosensitive drum 1. In the reference example, the developing device 4 uses a two-component developer which consists of toner (non-magnetic toner particle) and carrier (magnetic carrier particle). The developing device 4 includes a developing sleeve 401 as a developer carrying member and a developer container 402 which accommodates the developer. The developing sleeve 401 bears the developer in the developer container 402 and conveys it to a developing position, which is an opposing portion to the photosensitive drum 1. During development, the developing sleeve 401 is rotationally driven, when a driving force is transmitted from a drum driving portion, for example. Further, during development, a predetermined developing voltage (developing bias) is applied to the developing sleeve 401 by a developing power source (high voltage power source) as a developing voltage application portion which is not shown. Thus, the toner in the developer which is borne on the developing sleeve 401 is supplied onto the photosensitive drum 1 according to the electrostatic image, and a toner image is formed on the photosensitive drum 1. In the reference example, the toner which is charged with the same polarity as charged polarity of the photosensitive drum 1 (negative polarity in the reference example) adheres to an exposed portion (image portion) on the photosensitive drum 1 in which absolute value of potential is decreased by being exposed after uniformly charged (reversal developing method). In the reference example, normal charged polarity of the toner, which is a main charged property of the toner during development, is negative polarity. The toner is replenished from a toner cartridge 20 (20Y, 20M, 20C, 20K) as a developer replenishing container to the developing device 4 via a developer conveying portion (conveying passage) which is not shown in the figures.

An intermediary transfer belt 7, which is an intermediary transfer member which is configured of a rotatable, endless belt as a second image bearing member, is arranged opposing the four photosensitive drums 1Y, 1M, 1C and 1K. The intermediary transfer belt 7 is formed in an endless shape by dielectric resin such as polyimide. The intermediary transfer belt 7 is stretched with a predetermined tension by being stretched over a driving roller 71, a tension roller 72, an upstream auxiliary roller 73 and a secondary pre-transfer roller 74 as a plurality of stretching rollers (supporting rollers). The driving roller 71 is rotationally driven by transmitting a driving force from a belt driving portion which is not shown in the figures as a driving means. The intermediary transfer belt 7 rotates (circulating movement) in a direction of an arrow R2 (counterclockwise direction) in the figure when the driving force is transmitted by the driving roller 71. The tension roller 72 applies a predetermined tensile force (tension) to the intermediary transfer belt 7. The upstream auxiliary roller 73 is arranged on an upstream side of a primary transfer portion N1 which will be described below in a rotational direction of the intermediary transfer belt 7 (moving direction of the surface, conveying direction), and forms an image transfer surface which is arranged substantially horizontally together with the secondary pre-transfer roller 74. The secondary pre-transfer roller 74 forms the surface of the intermediary transfer belt 7 in a vicinity of the upstream side of the secondary transfer portion N2 which will be described below in a rotational direction of the intermediary transfer belt 7. The driving roller 71 also serves a function of a secondary transfer opposing roller (secondary transfer inner roller) as an opposing member (opposing electrode) of a secondary transfer roller 9 which will be described below. On the intermediary transfer belt 7, primary transfer rollers 8Y, 8M, 8C and 8K which are roller shaped primary transfer members as a primary transfer means, corresponding to the photosensitive drums 1Y, 1M, 1C and 1K, respectively. The primary transfer roller 8 presses against the photosensitive drum 1, contacts the photosensitive drum 1 via the intermediary transfer belt 7, and forms the primary transfer portion (primary transfer nip portion) N1 (NIY, NIM, NIC, NIK) which is a contact portion between the photosensitive drum 1 and the intermediary transfer belt 7. The stretching rollers other than the driving roller 71 and each primary transfer roller 8 are rotationally driven accompanied by the rotation of the intermediary transfer belt 7.

The toner image which is formed on the photosensitive drum 1 is transferred (primary transfer) onto the rotating intermediary transfer belt 7 which is rotating as a transferred member by an action of the primary transfer roller 8 at the primary transfer portion N1. During primary transfer, a primary transfer voltage (primary transfer bias) which is a DC voltage with a polarity which is opposite to a normal polarity of the toner (positive polarity in the reference example) is applied to the primary transfer roller 7 by a primary transfer power source (high-voltage power source) as a primary transfer voltage application portion which is not shown in the figure. For example, when forming a full color image, each color toner image of yellow, magenta, cyan and black which is formed on each photosensitive drum 1 is sequentially transferred so that they are superimposed on the intermediary transfer belt 7.

On an outer peripheral surface side of the intermediary transfer belt 7, a secondary transfer roller (secondary transfer outer roller) 9 as a roller shaped secondary transfer member (transfer rotatable member) as a secondary transfer means is arranged at a position which opposes the driving roller 71. The secondary transfer roller 9 presses against the driving roller 71, contacts the driving roller 71 via the intermediary transfer belt 7, and forms the secondary transfer portion (secondary transfer nip portion) N2 which is a contact portion between the intermediary transfer belt 7 and the secondary transfer roller 9. In the reference example, the secondary transfer roller 9 is rotationally driven accompanied by the rotation of the intermediary transfer belt 7. Incidentally, the secondary transfer roller 9 may be configured to be rotationally driven. The toner image which is formed on the intermediary transfer belt 7 is transferred (secondary transfer) onto the recording material P which is nipped between the intermediary transfer belt 7 and the secondary transfer roller 9 and conveyed as a transferred member by an action of the secondary transfer roller 9 at the secondary transfer portion N2. During secondary transfer, a secondary transfer voltage (secondary transfer bias) which is a DC voltage with a polarity which is opposite to the normal polarity of the toner (positive polarity in the reference example) is applied to the secondary transfer roller 9 by a secondary transfer power source (high-voltage power source) as a secondary transfer voltage application portion which is not shown in the figure. The driving roller (secondary transfer opposing roller) 71 is electrically grounded (connected to the ground). Incidentally, the secondary transfer voltage of the same polarity as the normal charging polarity of the toner may be applied to an inner roller corresponding to the driving roller 71 in the reference example, and an outer roller corresponding to the secondary transfer roller 9 in the reference example may be electrically grounded. The recording material (transfer member, sheet, recording medium) P is accommodated in a cassette 11 as a feeding portion (recording material accommodating portion). The recording material P is fed out one sheet at a time from the cassette 11 by a feeding roller 12 as a feeding member and is conveyed to a registration roller pair 13 as a recording material conveying member. After an attitude is aligned by the registration roller pair 13, the recording material P is conveyed to the secondary transfer portion N2 at a predetermined timing with respect to the toner image on the intermediary transfer belt 7.

The recording material P onto which the toner image is transferred is conveyed to a fixing device 10 as a fixing means. The fixing device 10 fixes (melts and adheres) the toner image to the surface of the recording material P by heating and pressing the recording material P which bears the un-fixed toner image. The recording material P on which the toner image is fixed is discharged (output) to a discharging tray 15 as a discharging portion which is provided outside (outside the apparatus) of a main assembly 110 (hereafter simply referred to as “the main assembly”) of the image forming apparatus 1, by the discharging roller pair 14 as a discharging member, etc.

On the other hand, the toner which remains on the photosensitive drum 1 after primary transfer (primary transfer residual toner) is removed from the photosensitive drum 1 and collected by the cleaning device 5 as a cleaning means. The cleaning device 5 scrapes off the primary transfer residual toner from the surface of the rotating photosensitive drum 1 with a blade 501 as a cleaning member which is arranged contacting the surface of the photosensitive drum 1, and accommodates the primary transfer residual toner in a collected toner accommodating portion 505. Details of the cleaning device 5 will be described below. Further, on the outer peripheral surface side of the intermediary transfer belt 7, at a position opposing the tension roller 72 via the intermediary transfer belt 7, a belt cleaning device 76 as an intermediary transfer member cleaning means is arranged. After secondary transfer, the toner which is remained on the intermediary transfer belt 7 (secondary transfer residual toner) and adhered material such as paper dust which is adhered to the intermediary transfer belt 7 from the recording material P is removed from the intermediary transfer belt 7 by the belt cleaning device 76 and collected. Further, the surface of the charging roller 2 is cleaned by the cleaning roller 6 which is a rotatable roller shaped charging member cleaning member as a charging member cleaning means, which is arranged contacting the surface of the charging roller 2.

In the reference example, the photosensitive drum 1, the charging roller 2, the cleaning roller 6 and the cleaning device (cleaning unit) 5 at each image forming portion S configure a drum cartridge 30 which is integrally mountable to and dismountable from a main assembly 110. Further, in the reference example, the developing device (developing unit) 4 in each image forming portion S configures a developing cartridge which is substantially independently mountable to and dismountable from the main assembly 110.

### 2. Drum Cartridge

Next, the drum cartridge 30 in the reference example will be described.

The drum cartridge 30 is configured while the photosensitive drum 1, the charging roller 2, the cleaning roller 6, the blade 501, etc. are held by a cleaning container (hereinafter also referred to as “container”) 504. The drum cartridge 30 is configured to be mountable to and dismountable from the main assembly 110, and is possible to be replaced for maintenance of the image forming apparatus 1 etc. The drum cartridge 30 is replaced with a new one in a case that the photosensitive drum 1 reaches an end of its life, for example.

In a container 504, the photosensitive drum 1 is rotatably supported via a bearing (not shown). The photosensitive drum 1 is rotationally driven when driving force is transmitted from a drum driving portion as a driving means which is provided with the main assembly 110. The photosensitive drum 1 rotates in the direction of the arrow R1 (clockwise direction) in the figure.

Further, in the container 504, the charging roller 2 is rotatably supported via a bearing (not shown). The charging roller 2 is pressed against the photosensitive drum 1 via its bearing by a pressing spring (not shown) which is an urging member as an urging means. The charging roller 2 is rotationally driven accompanied by the rotation of the photosensitive drum 1.

Further, in the container 504, the cleaning roller 6 is rotatably supported via a bearing (not shown). The cleaning roller 6 is pressed against the charging roller 2 via its bearing by a pressing spring (not shown) which is an urging member as an urging means. The cleaning roller 6 is rotationally driven accompanied by the rotation of the charging roller 2.

Incidentally, rotational axis directions of the photosensitive drum 1, the charging roller 2 and the cleaning roller 6 are substantially parallel to each other.

Further, as will be described in detail below, the drum cartridge 30 is provided with the cleaning device 5 which is configured with the collected toner accommodating portion 505 which is formed by the blade 501 and the container 504.

### 3. Cleaning Device

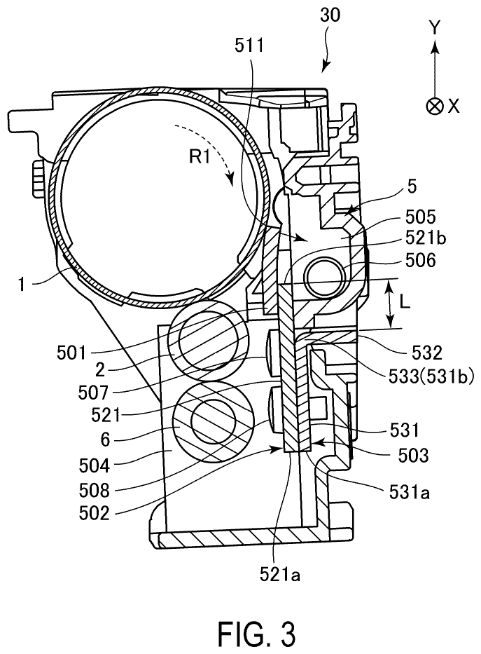

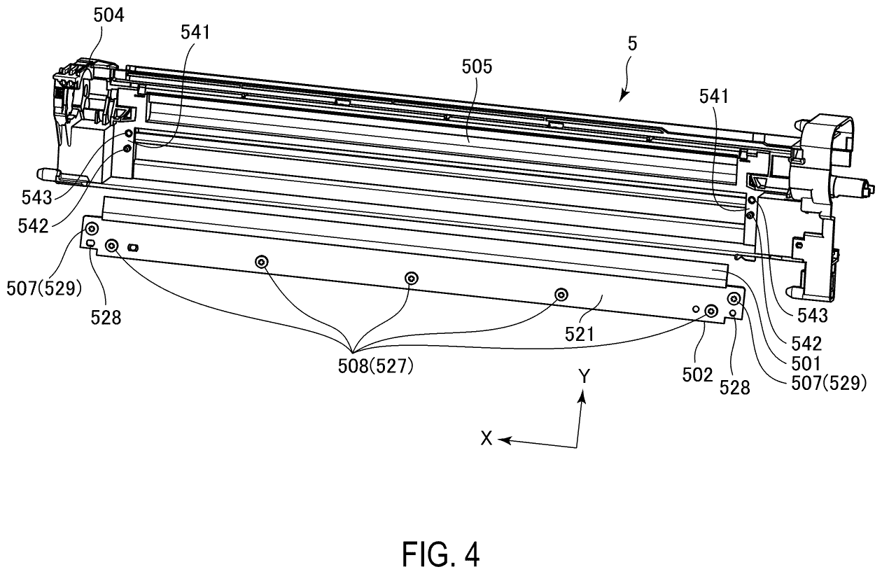

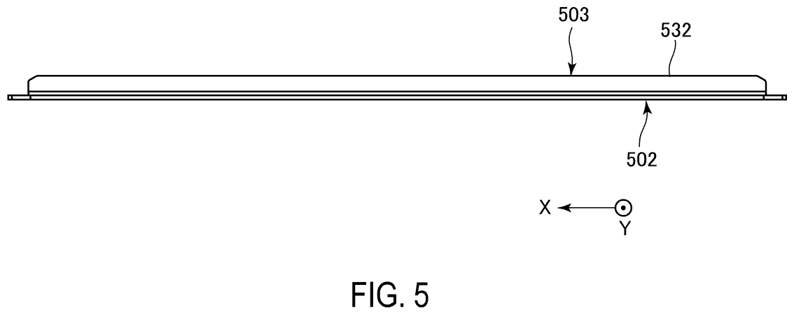

Next, the cleaning device 5 in the reference example will be described. FIG. 3 is a schematic cross sectional view of the drum cartridge 30 which is provided with the cleaning device 5 as the reference example. FIG. 4 is an exploded perspective view of the cleaning device 5 as the reference example when it is shown from a side of the photosensitive drum 1 (diagram of a conveying coil 506, which will be described below, is omitted). Further, FIG. 5 is a top view of a supporting configuration (a support plate 502 and a reinforcing plate 503, which will be described below) of the blade 501 in the cleaning device 5 as the reference example. FIG. 3, FIG. 4 and FIG. 5 are views showing the reference example of a shape of the reinforcing plate 503 among the supporting configuration of the blade 501 (the support plate 502 and the reinforcement plate 503).

Incidentally, with respect to the cleaning device 5 and its elements, a direction which is substantially parallel to the direction of the rotational axis of the photosensitive drum 1 is referred to as a longitudinal direction (a direction of an arrow X in the figure), and a direction which is substantially perpendicular to the longitudinal direction is referred to as a short side direction (a direction of an arrow Y in the figure). The rotational axis of the photosensitive drum 1 is in a direction which is substantially perpendicular to a direction of movement of the surface of the photosensitive drum 1. The cleaning device 5 is configured to include the blade (cleaning blade) 501 as a cleaning member, the support plate 502 as a supporting member, the reinforcing plate 503 as a reinforcing member, the container (cleaning container) 504 as a holding member, the collected toner accommodating portion 505 which is formed by the container 504, the conveying coil 506 as a conveying member, etc.

The blade 501 is formed of rubber such as urethane rubber which is an elastic material (elastic member). The blade 501 is a planar view substantially rectangular plate shaped (blade shaped) member which has a predetermined length in a longitudinal direction which is arranged substantially parallel to the direction of the rotational axis of the photosensitive drum 1, a predetermined length in a short side direction which is substantially perpendicular to the longitudinal direction and a predetermined thickness. The length of the blade 501 in the longitudinal direction is equivalent to the length of the photosensitive drum 1 in the direction of the rotational axis. The blade 501 is fixed to the support plate 502 on a surface of an opposite side of the photosensitive drum 1 at one end portion in the short side direction (lower end portion in the reference example). Further, as will be described below, the support plate 502 is mounted on the container 504, so the blade 501 is fixed to the container 504.

The support plate 502 is formed of a plate shaped member (metal plate) which is made of metal (SUS (stainless steel) in the reference example). The support plate 502 includes a blade fixing portion 521 (first flat portion) which is a flat plate part which extends along the direction of the rotational axis of the photosensitive drum 1. That is, the blade fixing portion 521 is a first flat portion which includes a fixing portion to which the blade 501 is fixed. As shown in FIG. 4, the support plate 502 is fixed to mounting surfaces 541 which are provided at both end portions of the container 504 with respect to the longitudinal direction by a support plate fixing screw 507 as a fixing means. On the mounting surfaces 541 at both end portions of the container 504 with respect to the longitudinal direction, a positioning portion (boss portion) 542 and a support plate fixing portion (screw hole portion) 543 are provided, respectively. Further, at both end portions of the support plate 502 with respect to the longitudinal direction, a positioning hole 528 and a support plate fixing hole (through hole) 529 are provided. And the support plate 502 is positioned by engaging the positioning hole 528 with the positioning portion 542, and is fixed to the mounting surface 541 by screwing the support plate fixing screw 507 to the support plate fixing portion 543. Further, the blade 501 is fixed (adhesively bonding) to on a surface of the blade fixing portion 521 on a side of the photosensitive drum 1 side of the support plate 502 by means of adhesion as a fixing means. A length of the blade 501 in a longitudinal direction is equal to a length of the support plate 502 which excludes an area in which the positioning hole 528 and the support plate fixing hole 529 are provided at both end portions of the support plate 502 with respect to the longitudinal direction.

The blade 501 is pressed against the surface of the photosensitive drum 1 so that an edge portion (hereafter also referred to as a “blade contacting portion”) 511 of one end portion (an upper end portion in the reference example) with respect to the short side direction is aligned with the direction of the rotational axis of the photosensitive drum 1. The blade 501 is arranged so that a free end portion which is the end portion which is described above is arranged to be positioned on an upstream side with respect to the rotational direction of the photosensitive drum 1 compared to a fixing end portion (a lower end portion in the reference example) and contacts against the surface of the photosensitive drum 1. That is, the blade 501 is contacted with the surface of the photosensitive drum 1 in a counter direction to the rotational direction of the photosensitive drum 1.

The blade 501 scrapes off and removes the toner from the surface of the rotating photosensitive drum 1 and accommodates it in the collected toner accommodating portion 505 which is formed by the container 504. The collected toner accommodating portion 505 is formed by the container 504 so that it is positioned on the opposite side of the photosensitive drum 1 across the blade 501. The conveying coil 506 is arranged in a vicinity of the blade 501 (in a vicinity of a bottom portion of the collected toner accommodating portion 505) along the rotational axis of the photosensitive drum 1. The conveying coil 506 is rotationally driven when a driving force is transmitted from a belt driving portion as a driving means which is provided with the main assembly 110, for example. The toner which is accommodated in the collected toner accommodating portion 505 (collected toner) is conveyed by the conveying coil 506 along the direction of the rotational axis of the photosensitive drum 1, for example, toward a rear side. And the toner which is conveyed by the conveying coil 506 is discharged to an outside of the drum cartridge 30 (the container 504) through a discharging port (not shown) which is provided in the container 504. The toner which is discharged from the drum cartridge 30 is conveyed to a collected toner box (not shown) as a developer collecting container (collecting portion) which is arranged in the main assembly 110 through a conveying portion (conveying passage), which is not shown, which is provided in the main assembly 110.

As described above, the blade 501 is contacted with the photosensitive drum 1 at a predetermined position and pressure, and the photosensitive drum 1 rotates in the direction of the arrow R1 in the figure. And the toner which is adhered to the surface of the rotating photosensitive drum 1 is scraped off by the blade 501 and is removed from the surface of the rotating photosensitive drum 1. The contact pressure of the blade 501 against the photosensitive drum 1 is important for cleaning performance of the cleaning device 5. When the contact pressure is higher than a predetermined contact pressure, the blade 501, the support plate 502 or the container 504 may vibrate by the excessive friction, and abnormal noise may be generated and the blade 501 may turn up. On the other hand, when the contact pressure is lower than a predetermined contact pressure, the toner on the surface of the photosensitive drum 1 may not be sufficiently scraped off by the blade 501, and an image defect may occur. When the support plate 502 which supports the blade 501 deforms due to reaction force of the contact pressure of the blade 501, it may have an effect on the contact pressure of the blade 501 and cause the problems which are described above.

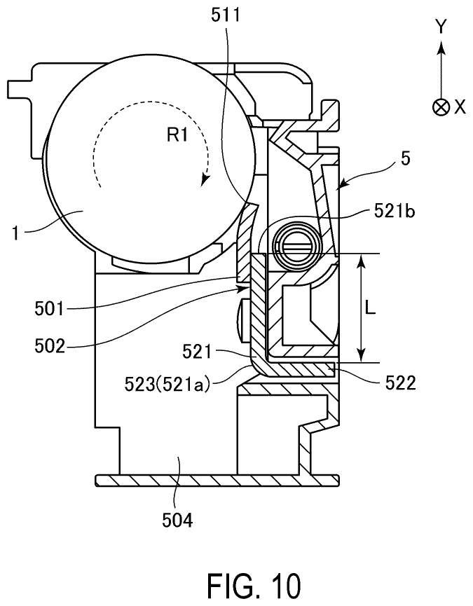

FIG. 10 is a schematic cross sectional view of a vicinity of the cleaning device in order to illustrate a configuration of a conventional cleaning device. Incidentally, the conventional cleaning device is also described by attaching the same reference numeral to the element which corresponds to that of the cleaning device in the reference example. As shown in FIG. 10, conventionally, in order to reduce deformation of the support plate 502, rigidity is increased by applying a bending process to the support plate 502. The support plate 502 which is shown in FIG. 10 includes a blade fixing portion 521 and a support plate projecting portion 522 which extends in a direction which intersects (substantially perpendicular in the example which is shown) with a plane of the blade fixing portion 521. That is, the support plate 502 includes a support plate bending portion (bending process portion) 523 which is bent to form the substantially L-shape in cross section. The support plate bending portion 523 is positioned at an end portion 521a (first the other end portion) of the blade fixing portion 521 which is opposite to the blade contact portion 511 in the short side direction of the blade fixing portion 521. Incidentally, the short side direction of the blade fixing portion 521 is a direction along the blade fixing portion 521 in a case that it is viewed along the longitudinal direction. Incidentally, the support plate projecting portion 522 extends to the opposite side of the photosensitive drum 1 with respect to the blade fixing portion 521.

However, in a case that the bending process is applied to the support plate 502, it is necessary to consider an effect on accuracy (flatness, etc.) of an adhered surface of the blade 501 on the support plate 502 and to ensure enough space for a fixing position of the support plate 502 to the container 504, etc. Therefore, a distance L between an adhered position of the blade 501 on the support plate 502 which receives the reaction force of the contact pressure of the blade 501 and the support plate bending portion 523, in the short side direction of the blade fixing portion 521, becomes larger. Here, the adhered position of the blade 501 on the support plate 502 is represented by an end portion 521b (first one end portion) of the blade fixing portion 521 on a side of the blade contact portion 511 in the short side direction of the blade fixing portion 521. That is, reinforcement is performed at a position which is distant from a position in which reinforcement is actually required on the support plate 502 (the adhered position of the blade 501 on the support plate 502 in which the support plate 502 receives the reaction force of the contact pressure of the blade 501). Therefore, in order to ensure sufficient rigidity of the support plate 502, it may be necessary to increase bending height of the support plate 502. However, when the bending height of the support plate 502 is increased, width of the cleaning device 5 become increase and it may lead to an enlargement of the image forming apparatus 100. In particular, as in the image forming apparatus 100 of the reference example, in a case that each image forming portion S is provided with an exposure device 3, each image forming portion S needs to secure space for that. Therefore, in a case of trying to miniaturize the image forming apparatus 100 by reducing a distance between the image forming portions S, it is important to make the width of the cleaning device 5 as small as possible.

Incidentally, in the support plate 502 which is shown in FIG. 10, the support plate projecting portion 522 extends to the opposite side of the photosensitive drum 1 with respect to the blade fixing portion 521. In response, it is possible to increase the bending height while the increase in the width of the cleaning device 5 is suppressed by extending the support plate projecting portion 522 towards the photosensitive drum 1. However, it is difficult to secure sufficient space on the side of the photosensitive drum 1 since a charging means is arranged, etc. When trying to avoid the charging means, the distance L which is described above becomes even larger, and the bending height of the support plate 502 needs to be made even higher, so it is not easy from a perspective of space and cost.

Thus, in the reference example, the reinforcing plate 503 is fixed to the support plate 502. The reinforcing plate 503 is formed from a plate shaped member which is made of metal (SUS in the reference example). The reinforcing plate 503 includes a fixing portion 531 (second flat portion) which is a flat plate shaped portion which extends along the rotational axis of the photosensitive drum 1, and a projecting portion 532 which extends in a direction which intersects (substantially perpendicular in the reference example) the plane of the fixing portion 531. That is, the reinforcing plate 503 includes a bending portion (bending process portion) 533 which is bent to form the substantially L-shape in cross section. The bending portion 533 is positioned at the end portion 531b (second the other end portion) on a side of the blade contact portion 511 of the fixing portion 531 in the short side direction of the fixing portion 531. Further, the projecting portion 532 extends to an opposite side of the photosensitive drum 1 with respect to the fixing portion 531. Incidentally, a short side direction of the fixing portion 531 is a direction along the fixing portion 531 in a case that it is viewed along a longitudinal direction.

Here, the projecting portion 532 is not limited to extending in a direction which is substantially perpendicular to the fixing portion 531, however, for example, it may extend in a direction at an angle of ±45 degrees or preferably ±30 degrees from a direction which is perpendicular to the fixing portion 531. Incidentally, this is similar to a direction of extension of a second projecting portion 534 which will be described in the embodiment below and a direction of extension of a support plate projecting portion 524 with respect to the blade fixing portion 521 which will be described in the embodiment. Further, “substantially perpendicular” includes a case in which an angle deviates from perpendicular by a certain amount of error (for example ±15 degrees), other than a case in which an angle is exactly perpendicular. Further, “substantially parallel” includes a case in which an angle deviates from parallel by a certain amount of error (for example ±15 degrees), other than a case in which an angle is exactly parallel.

As shown in FIG. 3 and FIG. 4, the reinforcing plate 503 is fixed to the support plate 502 at a plurality of positions along the longitudinal direction by a reinforcing plate fixing screw 508 as a fixing means. The support plate 502 is provided with reinforcing plate fixing holes (through holes) 527 at a plurality of positions (five positions in the reference example) in the longitudinal direction of the blade fixing portion 521. And the reinforcing plate 503 is fixed to the support plate 502 by screwing the reinforcing plate fixing screw 508 to the fixing portion 531 of the reinforcing plate 503 through each of the reinforcing plate fixing holes 527. At this time, a screw hole may be prepared on the reinforcing plate 503 in advance and the reinforcing plate fixing screw 508 may screw into the screw hole, or the reinforcing plate fixing screw 508 may screw into the reinforcing plate 503 by self-tapping. Further, as shown in FIG. 5, a length of the reinforcing plate 503 in a longitudinal direction is equal to a length of the support plate 502 in a longitudinal direction which excludes an area in which the positioning holes 528 and the support plate fixing holes 529 are provided at both end portions of the support plate 502 with respect to the longitudinal direction. That is, the length of the reinforcing plate 503 in the longitudinal direction is equal to the length of the blade 501 in the longitudinal direction.

In this way, in the reference example, the reinforcing plate 503 which is bent is fixed to the support plate 502. By reinforcing the support plate 502 with an alternative member, it is no longer subject to the restrictions of the aforementioned support plate 502. Therefore, it is possible to reduce a distance L between the adhered position of the blade 501 on the support plate 502 which receives the reaction force of the contact pressure of the blade 501 in the short side direction of the fixing portion 531 (or in the short side direction of the blade fixing portion 521) and the bending portion 533. That is, the bending portion 533 of the reinforcing plate 503 is possible to be positioned closer to a side of the blade contact portion 511 of the blade fixing portion 521 than the end portion 521a (first the other end portion) on the opposite side of the blade contact portion 511 in the short side direction of the fixing portion 531. For example, the bending portion 533 of the reinforcing plate 503 is positioned closer to the side of the blade contact portion 511 than an intermediate position (a central position of the support plate 502 with respect to the short side direction of the blade 501) between the fixing position (adhered position, fixing portion) of the blade 501 at the blade fixing portion 521 of the support plate 502 and the end portion 521a on the opposite side of the blade contact portion 511 of the blade fixing portion 521 in the short side direction of the fixing portion. Typically, the bending portion 533 of the reinforcing plate 503 is positioned closer to the side the blade contact portion 511 than the fixed position (support plate fixing portion 543) of the support plate 502 relative to the container 504 in the short side direction of the fixing portion 531.

Therefore, it is possible to reinforce at a position in which the distance L which is described above is small. In this way, since it is possible to reinforce the support plate 502 in a position close to a position in which reinforcement is actually required (the adhered position of the blade 501 on the support plate 502 in which the support plate 502 receives the reaction force of the contact pressure of the blade 501), it is possible to reinforce efficiently. Thus, it is possible to reinforce at a lower bending height. As a result, it is possible to reduce the width of the cleaning device 5 and to miniaturize the image forming apparatus 100.

Here, when an alternative member is inserted between the support plate 502 and the reinforcing plate 503, differences in flatness and thermal expansion between the members may affect the contact pressure of the blade 501. For this reason, it is desirable to fix the support plate 502 and the reinforcing plate 503 directly. In the reference example, a surface of the blade fixing portion 521 and a surface of the fixing portion 531 are contacted directly and the support plate 502 and the reinforcing plate 503 are fixed. Further, from a similar perspective, it is desirable that the support plate 502 and the reinforcing plate 503 are made of the same material. In the reference example, the support plate 502 and the reinforcing plate 503 are each configured of metal plate made of SUS which is same material.

Incidentally, in the reference example, the support plate 502 and the reinforcing plate 503 are fixed with screws at five points in the longitudinal direction, however, the present invention is not limited thereto. The support plate 502 and the reinforcing plate 503 may be fixed without affecting the contact pressure of the blade 501. Further, the reinforcing plate 503 is not limited to being fixed to the support plate 502 by screws and, it is possible to fix the reinforcing plate 503 to the support plate 502 by any other fixing means such as spot welding, for example.

Further, in the reference example, the reinforcing plate 503 is provided on the opposite side of the photosensitive drum 1 with respect to the support plate 502 and the projecting portion 532 extends toward the opposite side of the photosensitive drum 1, however, the present invention is not limited thereto. When it is acceptable from a perspective of space, etc., the reinforcing plate 503 may be provided on the photosensitive drum 1 side of the support plate 502, and the projecting portion 532 may extend toward the photosensitive drum 1 side.

In this way, in the reference example, the cleaning device 5 contacts the surface of the image bearing member (photosensitive drum) 1 along the longitudinal direction X and includes the blade (cleaning blade) 501 which removes the toner from the surface of the image bearing member 1 at the contact portion (blade contact portion) 511 against the image bearing member 1, the support plate 502 which supports the blade 501, and the reinforcing plate 503 which is fixed to the support plate 502, the support plate 502 is arranged along the longitudinal direction X which is described above and is provided with the blade fixing portion 521 to which the blade 501 is fixed, the reinforcing plate 503 is arranged along the blade fixing portion 521, and is provided with the fixing portion 531 which is fixed to the blade fixing portion 521 and the projecting portion 532 which is provided so as to project from the fixing portion 531 at one end portion 531b of the fixing portion 531 on the side of the contact portion 511 which is described above in the direction along the fixing portion 531 in the case that it is viewed along the longitudinal direction X which is described above, and the one end portion 531b which is described above of the fixing portion 531 is positioned closer to the side of the contact portion 511 which is described above than the end portion 521a on the opposite side of the contact portion 511 which is described above of the blade fixing portion 521 in the direction along the fixing portion 531 (the short side direction of the blade 501) in the case that it is viewed along the longitudinal direction X which is described above. In the reference example, the reinforcing plate 503 is arranged along the blade fixing portion 521, and is provided with a fixing portion 531 which is fixed to a surface of the blade fixing portion 521 which is an opposite side of the image bearing member 1, and the projecting portion 532 which is provided to project from the fixing portion 531 to the opposite side of the image bearing member 1 at one end portion 531b of the fixing portion 531 on the side of the contact portion 511 which is described above in the direction along the fixing portion 531 when it is viewed along the longitudinal direction X which is described above, the one end portion 531b which is described above of the fixing portion 531 is positioned closer to the side of the contact portion 511 which is described above than the end portion 521a which is the opposite side of the contact portion 511 which is described above of the blade fixing portion 521 when it is viewed along the longitudinal direction X which is described above. For example, the one end portion 531b which is described above of the fixing portion 531 is positioned closer to the side of the contact portion 511 which is described above than an intermediate position between the end portion 521a which is opposite side to the contact portion 511 which is described above of the blade fixing portion 521 and the position in which the blade 501 is fixed in the blade fixing portion 521 (a position of half distance between them) when it is viewed along the longitudinal direction X which is described above. Typically, the cleaning device 5 includes the container (cleaning container) 504 which is provided with the support plate fixing portion 543 to which the support plate 502 is fixed, and the one end portion 531b which is described above of the fixing portion 531 is positioned closer to the side of the contact portion which is described above than the support plate fixing portion 543 in the direction along the fixing portion 531 when it is viewed along the longitudinal direction X which is described above. In the reference example, the reinforcing plate 503 is fixed to the support plate 502 so that the surface of the fixing portion 531 contacts the surface of the blade fixing portion 521. Further, in the reference example, the support plate 502 and the reinforcing plate 503 are made of the same material. Further, according to the reference example, the image forming apparatus 100, which includes the image bearing member 1 on which the toner image is formed and the cleaning device 5 which is configured as described above, is offered.

As described above, according to the reference example, it is possible to effectively increase rigidity of a support configuration of the blade 501 in a small space. Thus, it is possible to suppress changing the contact pressure of the blade 501 by suppressing deformation of the support plate 502 against a reaction force which is applied to the blade 501. As a result, it is possible to properly clean the photosensitive drum 1 and suppress an occurrence of a cleaning defect. Further, it is possible to suppress generating abnormal noise and an occurrence of turn-up of the blade 501.

### EMBODIMENT

Next, the embodiment of the present invention will be described. A basic configuration and operation of the image forming apparatus according to the embodiment are the same as those of the reference example. Therefore, in the image forming apparatus according to the embodiment, for an element which has the same or corresponding function or configuration as those of the image forming apparatus of the reference example, the same reference numeral as those of the image forming apparatus of the reference example will be attached, and a detailed description will be omitted.

In the embodiment, modified examples (an embodiment 1-1, an embodiment 1-2, an embodiment 1-3) of the support configuration of the blade 501 (the support plate 502 and the reinforcing plate 503).

### Embodiment 1-1

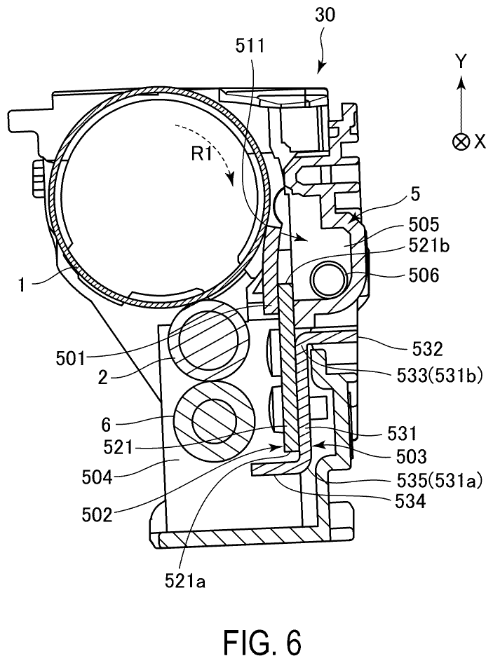

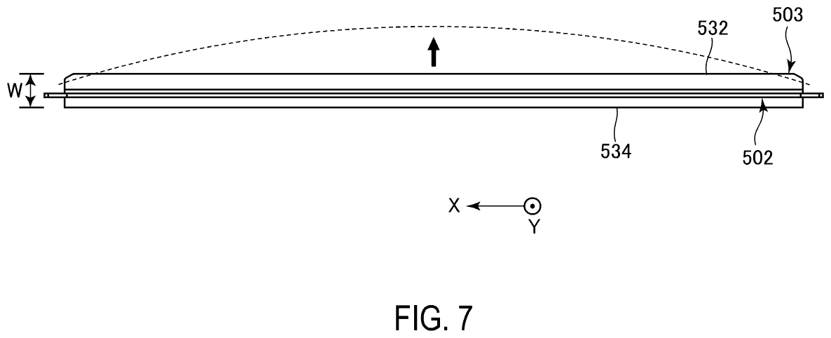

FIG. 6 is a schematic cross sectional view of the drum cartridge 30 which is provided with the cleaning device 5 according to the embodiment 1-1. Further, FIG. 7 is a top view of the support configuration of the blade 501 (the support plate 502 and the reinforcing plate 503) in the cleaning device 5 according to the embodiment 1-1.

In the embodiment 1-1, in addition to the same configuration as the reference example, the reinforcing plate 503 includes a second bending portion 535 at the end portion 531a (second the other end portion) on the opposite side of the blade contact portion 511 of the fixing portion 531 (second flat portion) in the short side direction of the fixing portion 531 (flat portion). Thus, in the embodiment 1-1, the reinforcing plate 503 includes the second projecting portion 534 (second projecting portion) which extends toward the side of the photosensitive drum 1 from the fixing portion 531. In the embodiment 1-1, a bending height of the second projecting portion 534 is smaller than a bending height of the projecting portion 532 (first projecting portion).

The container 504 supports both end portions of the photosensitive drum 1 in the direction of the rotational axis, and it receives the reaction force of the blade 501 from the mounting surface 541 to which the support plate 502 is fixed. Therefore, the container 504 may bend in a middle portion in the longitudinal direction, as shown by an arrow in FIG. 7. By applying bending process to both end portions in the short side direction of the reinforcing plate 503, it is possible to increase a width (thickness in a direction which is substantially perpendicular to a longitudinal direction and a short side direction) W of the reinforcing plate 503 which contributes to rigidity of the container 504 to counter deformation which bends in a middle portion of the container 504 in the longitudinal direction. Thus, it is possible to reduce deformation not only of the support plate 502 but also of the container 504.

Incidentally, in the embodiment 1-1, the reinforcing plate 503 is provided with the support plate 502 on the opposite side of the photosensitive drum 1, and the projecting portion 532 extends toward the opposite side of the photosensitive drum 1, and the second projecting portion 534 extends toward the side of the photosensitive drum 1 side, however, the present invention is not limited thereto. When it is acceptable from a perspective of space, etc., the reinforcing plate 503 may be provided with the support plate 502 on the side of the photosensitive drum 1. And the projecting portion 532 may extend toward the side of the photosensitive drum 1, and the second projecting portion 534 may extend toward the opposite side of the photosensitive drum 1. When the projecting portion 532 and the second projecting portion 534 project in opposite directions each other, it is possible to obtain a similar effect.

Here, in the embodiment 1-1 (the embodiment 1-2 and the embodiment 1-3 which will be described below are also similar), the element which has the same or corresponding function or configuration as those of the image forming apparatus of the reference example among the supporting configuration of the blade 501 (the support plate 502 and the reinforcement plate 503) will be described. In the embodiment 1-1 (the embodiment 1-2 and the embodiment 1-3 which will be described below are also similar), on the mounting surfaces 541 at both end portions of the container 504 with respect to the longitudinal direction, the positioning portion (boss portion) 542 and the support plate fixing portion (screw hole portion) 543 are provided, respectively (see FIG. 4).

Further, in the embodiment 1-1 (the embodiment 1-2 and the embodiment 1-3 which will be described below are also similar), on both end portions of the support plate 502 with respect to the longitudinal direction, the positioning hole 528 and the support plate fixing holes (through holes) 529 are provided (see FIG. 4).

Further, in the embodiment 1-1 (the embodiment 1-2 and the embodiment 1-3 which will be described below are also similar), the length of the blade 501 in the longitudinal direction is equal to the length of the support plate 502 in the longitudinal direction which excludes the area in which the positioning holes 528 and the support plate fixing holes (through holes) 529 are provided at both end portions of the support plate 502 with respect to the longitudinal direction (see FIG. 4).

Further, in the embodiment 1-1 (the embodiment 1-2 and the embodiment 1-3 which will be described below are also similar), the length of the reinforcing plate 503 in the longitudinal direction is equal to the length of the support plate 502 in the longitudinal direction which excludes the area in which the positioning holes 528 and the support plate fixing holes 529 are provided at both end portions of the support plate 502 with respect to the longitudinal direction. That is, the length of the reinforcing plate 503 in the longitudinal direction is equal to the length of the blade 501 in the longitudinal direction.

Further, in the embodiment 1-1 (the embodiment 1-2 and the embodiment 1-3 which will be described below are also similar), the reinforcing plate 503 is fixed to the support plate 502 at the plurality of positions along the longitudinal direction by the reinforcing plate fixing screw 508 as the fixing means (see FIG. 4).

Further, in the embodiment 1-1 (the embodiment 1-2 and the embodiment 1-3 which will be described below are also similar), the positioning holes 528 and the support plate fixing holes 529 at both end portions of the support plate 502 with respect to the longitudinal direction is positioned outside the area in which the blade 501 is arranged with respect to the longitudinal direction (the direction of the arrow X in the figure) which is substantially parallel to the direction of the rotational axis of the photosensitive drum 1 (see FIG. 4). The reason will be described below.

In a case that the positioning holes 528 and the support plate fixing holes 529 at both end portions of the support plate 502 with respect to the longitudinal direction are positioned inside an area in which the blade 501 is provided with respect to the longitudinal direction (the direction of the arrow X in the figure), it is not possible to fix the support plate 502 to the container 504 since the reinforcing plate 503 is provided within an area in which the blade 501 is provided with respect to the longitudinal direction (the direction of the arrow X in the figure).

So, in the embodiment 1-1 (the embodiment 1-2 and the embodiment 1-3 which will be described below are also similar), on the mounting surfaces 541 at both end portions of the container 504 with respect to the longitudinal direction, the positioning portion (boss portion) 542 and the support plate fixing portion (screw hole portion) 543 are provided, respectively, and on both end portions of the support plate 502 with respect to the longitudinal direction, the positioning hole 528 and the support plate fixing hole (through hole) 529 are provided (see FIG. 4).

Therefore, with respect to the longitudinal direction (the direction of the arrow X in the figure), the positioning holes 528 and the support plate fixing holes 529 are positioned in an area in which the blade 501 is not provided (that is, an area in which the reinforcing plate 503 is not provided), so it is possible to fix the support plate 502 to the container 504 (see FIG. 4).

Further, in the embodiment 1-1 (the embodiment 1-2 and the embodiment 1-3 which will be described below are also similar), the positioning holes 528 and the support plate fixing holes 529 are arranged in a short direction (a direction of an arrow Y in the figure), which is substantially perpendicular to the longitudinal direction (the direction of the arrow X in the figure) (see FIG. 4). The reason will be described below.

In a case that the positioning holes 528 and the support plate fixing holes 529 are arranged along the longitudinal direction (the direction of the arrow X in the figure), a spacing gear (unshown in the figure) in which the charging roller 2 contacts with and spaces from the photosensitive drum 1 may interfere with the support plate fixing screw 507 which is screwed to the support plate fixing portion 543. Therefore, it is necessary to release a position of the support plate fixing screw 507 so that the spacing gear (unshown in the figure) does not interfere with the support plate fixing screw 507 which is screwed to the support plate fixing portion 543.

So when the positioning holes 528 and the support plate fixing holes 529 are arranged in the area in which the blade 501 is not provided (that is, the area in which the reinforcing plate 503 is not provided), in the embodiment 1-1 (the embodiment 1-2 and the embodiment 1-3 which will be described below are also similar), it is arranged as will be described below. That is, in the embodiment 1-1 (the embodiment 1-2 and the embodiment 1-3 which will be described below are also similar), the positioning holes 528 and the support plate fixing holes 529 are not arranged along the longitudinal direction (the direction of the arrow X in the figure), but arranged along the short direction (the direction of the arrow Y in the figure) (see FIG. 4).

Furthermore, in the embodiment 1-1 (the embodiment 1-2 and the embodiment 1-3 which will be described below are also similar), the support plate fixing holes 529 are arranged above the positioning holes 528 with respect to the short direction (the direction of the arrow Y in the figure). This is advantageous since a moment is smaller than when the support plate fixing holes 529 are arranged below the positioning holes 528 with respect to the short direction (the direction of the arrow Y in the figure). Because a distance between a leading end of the blade 501 which receives a reaction force of a contact pressure of the blade 501 and the support plate fixing screw 507 when the support plate fixing holes 529 are arranged above the positioning holes 528 with respect to the short direction (the direction of the arrow Y in the figure) is shorter than when it is arranged below the positioning holes 528.

Furthermore, in the embodiment 1-1 (the embodiment 1-2 and the embodiment 1-3 which will be described below are also similar), each of the reinforcing plate fixing holes 527 is arranged in a position which is lower than the support plate fixing holes 529 with respect to the short direction (the direction of the arrow Y in the figure) (see FIG. 4). Therefore, it is possible to improve accuracy of each of the reinforcing plate fixing holes 527 since it is possible to separate the position of each reinforcing plate fixing hole 527 from a bending portion (the projecting portion 532) of the reinforcing plate 503.

### Embodiment 1-2

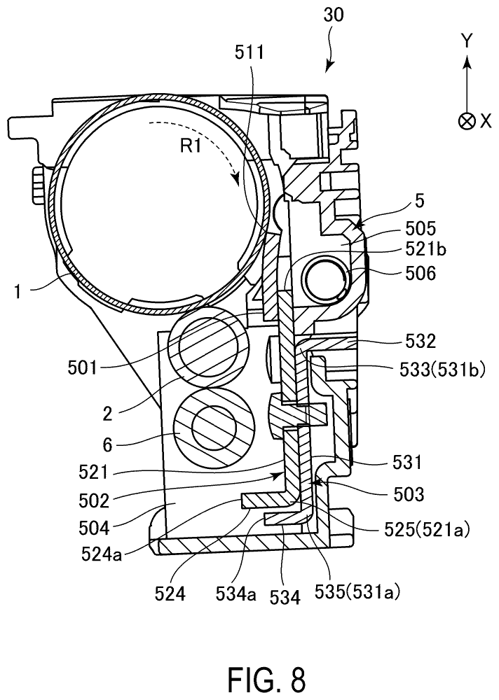

FIG. 8 is a schematic cross sectional view of the drum cartridge 30 which is provided with the cleaning device 5 according to the embodiment 1-2.

In the embodiment 1-2, in addition to a similar configuration to the embodiment 1-1, the support plate 502 includes the support plate bending portion 525 at the end portion 521a, which is opposite to the blade contact portion 511, of the blade fixing portion 521 in the short side direction of the blade fixing portion 521 (first flat portion). Thus, in the embodiment 1-2, the support plate 502 includes the support plate projecting portion 524 which extends toward the side of the photosensitive drum 1 from the blade fixing portion 521.

Due to such a configuration, it is possible to further increase the rigidity of the support configuration of the blade 501. Further, in the embodiment 1-2, in the direction which is substantially perpendicular to the surface of the fixing portion 521 (the direction of the width W which is described above), a leading end 524a of the support plate projecting portion 524 projects more toward the side of the photosensitive drum 1 than the leading end 534a of the second projecting portion 534 of the reinforcing plate 503. Thus, it is possible to increase the width W which is described above than in the embodiment 1-1, as the overall support configuration of the blade 501 which is formed by the support plate 502 and the reinforcing plate 503. Thus, it is possible to enhance an effect of reducing deformation not only of the support plate 502 but also of the container 504 more than the embodiment 1-1.

Incidentally, in the embodiment 1-2, the support plate projecting portion 524 extends toward the side of the photosensitive drum 1, however, the present invention is not limited thereto. As described above, the reinforcing plate 503 may be provided with the support plate 502 on the side of the photosensitive drum 1. In such a case, the support plate projecting portion 524 may extend toward the opposite side of the photosensitive drum 1. By providing the support plate projecting portion 524, it is possible to obtain the effect to enhance the rigidity of the support plate 502 itself regardless of its orientation. Further, when the projecting portion 532 and the support plate projecting portion 524 project in opposite directions each other, it is possible to obtain by increasing the above width W the similar effect to what is described above.

### Embodiment 1-3

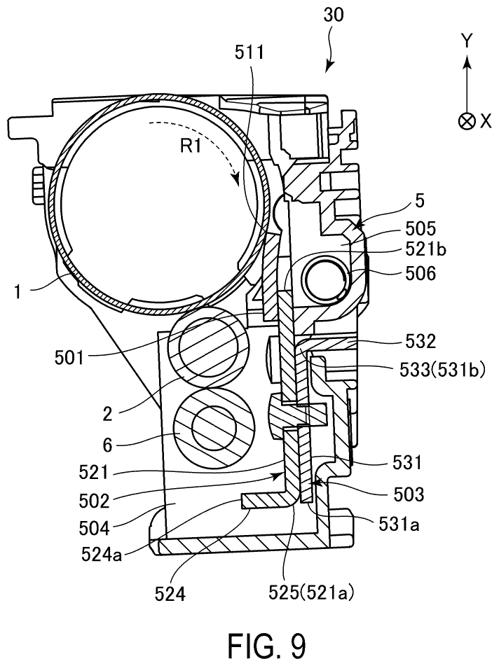

FIG. 9 is a schematic cross sectional view of the drum cartridge 30 which is provided with the cleaning device 5 according to the embodiment 1-3.

In the embodiment 1-3, the support plate 502 includes the support plate projecting portion 524 which is similar to that according to the embodiment 1-2, however, the reinforcing plate 503 does not include the second projecting portion 534 which is like that according to the embodiment 1-1 (similar to the reference example).

When bending process is applied to both end portions of the reinforcing plate 503 with respect to the short side direction, it may become difficult to process. On the other hand, it is sometimes desirable to enhance the rigidity of the support plate 502 itself, for example, when the blade 501 is fixed to the support plate 502 or when the support plate 502, to which the blade 501 is fixed, is fixed to the container 504, etc. Therefore, the support plate 502 is provided with the support plate projecting portion 524 (second projecting portion), and, in addition, the reinforcing plate 503 is not provided with the second projecting portion 534 but provided with only the projection portion 532 (first projecting portion). Thus, it is possible to enhance the rigidity of the support plate 502 itself, and further while making it easier to process the reinforcing plate 503, it is possible to increase the width W which is described above as the overall support configuration of the blade 501 which is formed by the support plate 502 and the reinforcing plate 503. Thus, while making it easier to manufacture the cleaning device 5, it is possible to obtain by increasing the above width W the effect of reducing deformation not only of the support plate 502 but also of the container 504.

Incidentally, similar to the case of the embodiment 1-2, the support plate projecting portion 524 may extend toward the side of the photosensitive drum 1 and may extend toward the opposite side of the photosensitive drum 1. By providing the support plate projecting portion 524, it is possible to obtain the effect to enhance the rigidity of the support plate 502 itself regardless of its orientation. Further, when the projecting portion 532 and the support plate projecting portion 524 project in opposite directions each other, it is possible to obtain the similar effect to what is described above.

In this way, the reinforcing plate 503 may include the second projecting portion 534 which is provided so as to project from the fixing portion 531 at the end portion 531a which is on the opposite side of one end portion 531b which is provided with the projecting portion 532 of the fixing portion 531 in the direction along the fixing portion 531 (short side direction of the blade 501) when it is viewed along the longitudinal direction X of the blade 501. In this case, it is preferable that the projecting portion 532 and the second projecting portion 534 project in opposite directions each other. Further, in this case, typically, similar to the reference example, the projecting portion 532 is provided so as to project toward the opposite side of the image bearing member 1. And typically the reinforcing plate 503 includes the second projecting portion 534 which is provided so as to project toward the side of the image bearing member 1 from the fixing portion 531 at the end portion 531a which is on the opposite side of one end portion 531b, which is described above, of the fixing portion 531 in the direction along the fixing portion 531 when it is viewed along the longitudinal direction which is described above. Further, the support plate 502 may include the support plate projecting portion 524 which is provided so as to project from the blade fixing portion 521 at the end portion 521a which is on the opposite side of the contact portion (the contact portion of the blade 501 against the image bearing member 1) 511 of the blade fixing portion 521 in the direction along the blade fixing portion 521 (short side direction of the blade 501) when it is viewed along the longitudinal direction X which is described above. In this case, it is preferable that the projecting portion 532 and the support plate projecting portion 524 project in opposite directions each other. Further, in this case, typically, similar to the reference example, the projecting portion 532 is provided so as to project toward the opposite side of the image bearing member 1. And typically, the support plate 502 includes the support plate projecting portion 524 which is provided so as to project from the blade fixing portion 521 toward the side of the image bearing member at the end portion 521a which is on the opposite side of the contact portion 511 which is described above of the blade fixing portion 521 in the direction along the blade fixing portion 521 when it is viewed along the longitudinal direction X which is described above. Further, the reinforcing plate 503 may include the projecting portion 532 and the second projecting portion 534, and the support plate 502 may include the support plate projecting portion 524. In this case, it is preferable that the projecting portion 532 and the second projecting portion 534 project in opposite directions each other and the projecting portion 532 and the support plate projecting portion 524 project in opposite directions each other. In this case, typically, as described above, the projecting portion 532 is provided so as to project toward the opposite side of the image bearing member 1, the second projecting portion 534 is provided so as to project toward the side of the image bearing member 1, and the support plate projecting portion 524 is provided so as to project toward the side of the image bearing member 1. Further, in this case, for example, when it is viewed along the longitudinal direction X which is described above, in the direction which is substantially perpendicular to the surface of the blade fixing portion 521, a leading end 524a of the support plate projecting portion 524 is positioned closer to the side of the image bearing member 1 than the leading end 534a of the second projecting portion 534.

As described above, according to the embodiment, it is possible to obtain the similar effect to the reference example, and in addition, it is possible to further suppress changes in the contact pressure of the blade 501 by reducing deformation not only of the support plate 502 but also of the container 504.

### Others

As described above, the present invention is described according to the specific embodiments, however, the present invention is not limited to the embodiments which are described above.

In the embodiments which are described above, the present invention is applied to a cleaning device for cleaning a photosensitive drum (first image bearing member), however, the present invention is not limited thereto. For example, the present invention may be applied to a cleaning device which cleans an intermediary transfer member (second image bearing member) such as an intermediary transfer belt. Further, the photosensitive member is not limited to being drum shaped, and may be, for example, an endless belt. Further, the image bearing member may be an electrostatic recording dielectric.

Further, in the embodiments which are described above, the support configuration of the blade is fixed to the container. The present invention is particularly effective in suppressing changes in the contact pressure of the blade due to deformation of the support configuration of the blade in such a configuration, however, the present invention is not limited thereto. There is a configuration in which the support configuration of the blade is movable (for example swingable) with respect to the container, and it is also possible to apply the present invention in order to enhance the rigidity of the support configuration of the blade in such a configuration.

Further, the image forming apparatus is not limited to a color image forming apparatus, and the present invention is also possible to apply to a monochrome image forming apparatus.

According to the present invention, it is possible to increase effectively the rigidity of the blade support configuration in a small amount of space.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications Nos. 2023-217491 filed on Dec. 23, 2023, and 2024-212383 filed on Dec. 5, 2024, which is hereby incorporated by reference herein in its entirety.

1. A cleaning device comprising:
a blade in contact with a surface of an image bearing member along a longitudinal direction and configured to remove toner from the surface of the image bearing member in a contacting portion to the image bearing member;
a support plate configured to support the blade;
a reinforcing plate fixed to the support plate;
wherein the support plate is provided with a first flat portion disposed along the longitudinal direction and including a fixing portion to which the blade is fixed, a first one end portion of the first flat portion on a side close to the contacting portion with respect to a short side direction of the blade, and a first the other end portion of the first flat portion on a side far from the contacting portion;
wherein the reinforcing plate is provided with a second flat portion disposed along the longitudinal direction so as to be along the first flat portion, a second one end portion of the second flat portion on a side close to the contacting portion with respect to the short side direction of the blade, and a second the other end portion of the second flat portion on a side far from the contacting portion; and
wherein as viewed in the longitudinal direction, the second one end portion is provided with a first projecting portion projecting from the second flat portion in a first direction crossing the short side direction of the blade and the second the other end portion is provided with a second projecting portion projecting from the second flat portion in a second direction opposite to the first direction.

2. The cleaning device according to claim 1, wherein the first projecting portion is positioned at a side closer to the contacting portion than a center position of the support plate with respect to the short side direction of the blade.

3. The cleaning device according to claim 1, further comprising a container provided with a support plate fixing portion to which the first flat portion is fixed.

4. The cleaning device according to claim 3, wherein the first projecting portion is positioned at a side closer to the contacting portion than the support plate fixing portion with respect to the short side direction of the blade.

5. The cleaning device according to claim 1, wherein the first the other end portion of the support plate includes a support plate projecting portion provided so as to project from the first flat portion.

6. The cleaning device according to claim 1, wherein the reinforcing plate is fixed to the support plate so that the second flat portion is in contact with the first flat portion.

7. The cleaning device according to claim 1, wherein the support plate and the reinforcing plate are formed of a same material.

8. The cleaning device according to claim 1, wherein the first projecting portion and the second projecting portion are formed by bending the reinforcing plate.

9. A cleaning device comprising:
a blade in contact with a surface of an image bearing member along a longitudinal direction and configured to remove toner from the surface of the image bearing member in a contacting portion to the image bearing member;
a support plate configured to support the blade;
a reinforcing plate fixed to the support plate;
wherein the support plate is provided with a first flat portion disposed along the longitudinal direction and including a fixing portion to which the blade is fixed, a first one end portion of the first flat portion on a side close to the contacting portion with respect to a short side direction of the blade, and a first the other end portion of the first flat portion on a side far from the contacting portion;
a container provided with a support plate fixing portion to which the first flat portion of the support plate is fixed;
wherein the reinforcing plate is provided with a second flat portion disposed along the longitudinal direction so as to be along the first flat portion, a second one end portion of the second flat portion on a side close to the contacting portion with respect to the short side direction of the blade, and a second the other end portion of the second flat portion on a side far from the contacting portion; and
wherein as viewed in the longitudinal direction, the second one end portion is provided with a projecting portion projecting from the second flat portion in a first direction crossing the short side direction of the blade and the first the other end portion is provided with a support plate projecting portion projecting from the first flat portion in a second direction opposite to the first direction.

10. The cleaning device according to claim 9, wherein the projecting portion is positioned at a side closer to the contacting portion than a center position of the support plate with respect to the short side direction of the blade.

11. The cleaning device according to claim 9, wherein the projecting portion is positioned at a side closer to the contacting portion than the support plate fixing portion with respect to the short side direction of the blade.

12. The cleaning device according to claim 9, wherein the reinforcing plate is fixed to the support plate so that the second flat portion is in contact with the first flat portion.

13. The cleaning device according to claim 9, wherein the support plate and the reinforcing plate are formed of a same material.

14. The cleaning device according to claim 9, wherein the projecting portion is formed by bending the reinforcing plate and the support plate projecting portion is formed by bending the support plate.
